(19) United States
(12) Patent Application Publication
(10) Pub. No.: US 2012/0255388 A1
(43) Pub. Date: Oct. 11, 2012

(54) LINE MANAGEMENT SYSTEM AND A METHOD FOR ROUTING FLEXIBLE LINES FOR A ROBOT

(76) Inventor: Stan H. McClosky, Rochester Hills, MI (US)

(21) Appl. No.: 13/080,005

(22) Filed: Apr. 5, 2011

(51) Int. Cl. B25J 18/00

(52) U.S. Cl. 74/490.02

(57) ABSTRACT

A line management system for a robot includes a flexible line, a structure clamp coupled to a first end of the flexible line to attach the flexible line to a support structure of the robot, an arm clamp coupled to the second end of the flexible line to attach the flexible line to an outer arm of the robot, a coupling device moveably coupled to the robot structure, wherein the flexible line is attached to the coupling device at an intermediate point along a length thereof.

### FIELD OF THE INVENTION

The present invention relates generally to a robot. In particular, the invention is directed to a line management system and a method for routing flexible lines such as cables and hoses for a robot.

### BACKGROUND OF THE INVENTION

Current methods for routing flexible lines (e.g. cables/hoses) can include a cable track to accommodate the motion of a robot arm. As another example, cables/hoses are supported aside the robot arm such that flexing can occur about an axis of rotation of a robot joint. As a further example, cables/hoses are routed inside a flexible conduit (e.g. vacuum hose) supported by clamps coupled to the robot arm.

Shortcomings of prior art include the following: a cable track is costly and multiple joints of a cable track can generate wear particles that can contaminate a work piece. Cables/hoses routed aside the robot arm create a larger total width of the joint that can interfere with the work environment, other robot arms, and/or the work piece. Cables/hoses routed inside flexible conduit are difficult to service and an individual hose must be dragged through the conduit for replacement.

It would be desirable to have a system and a method for routing cables/hoses for a robot, wherein the system and the method overcome the shortcomings of the prior art discussed above.

### SUMMARY OF THE INVENTION

Concordant and consistent with the present invention, a system and a method for routing cables/hoses for a robot, wherein the system and the method overcome the shortcomings of the prior art discussed herein above, have surprisingly been discovered.

In one embodiment, a line management system for a robot including a robot structure supporting an inner arm about a rotary shoulder axis and an outer arm supported by the inner arm about a rotary elbow axis, comprises: a flexible line; a structure clamp coupled to a first end of the flexible line to couple the flexible line to the robot structure, wherein a first axis of a cross section of the flexible line is substantially parallel to the shoulder axis at the first end of the flexible line; an arm clamp coupled to the second end of the flexible line to couple the flexible line to the outer arm, wherein the first axis of a cross section of the flexible line is substantially parallel to the elbow axis at the second end of the flexible line; and a coupling device moveably coupled to the robot structure, wherein the flexible line is attached to the coupling device at an intermediate point along a length thereof such that the first axis of the cross-section of the flexible line at the intermediate point is substantially parallel to at least one of the shoulder axis and the elbow axis.

In another embodiment, a robot comprises: a robot structure supporting an inner arm about a rotary shoulder axis and an outer arm supported by the inner arm about a rotary elbow axis; a plurality of flexible lines arranged in a bundle; a structure clamp coupled to a first end of the bundle to couple the bundle to the robot structure, wherein a first axis of a cross section of the bundle is substantially parallel to the shoulder axis at the first end of the bundle; an arm clamp coupled to a second end of the bundle to couple the bundle to the outer arm, wherein the first axis of a cross section of the bundle is substantially parallel to the elbow axis at the second end of the bundle; a crank arm supported by the robot structure; and a coupling device mounted to the crank arm, wherein the bundle is attached to the coupling device at an intermediate point along a length thereof to guide the bundle along a pre-determined motion path.

The invention also provides methods of routing a flexible line for a robot including a robot structure supporting an inner arm about a rotary shoulder axis and an outer arm supported by the inner arm about a rotary elbow axis.

One method comprises the steps of: supporting a first end of the flexible line with the robot structure, wherein a first axis of a cross section of the flexible line is substantially parallel to the shoulder axis at the first end of the flexible line; supporting a second end of the flexible line with the robot structure, wherein the first axis of a cross section of the flexible line is substantially parallel to the elbow axis at the second end of the flexible line; and supporting an intermediate point along a length of the flexible line such that the first axis of the cross-section of the flexible line at the intermediate point is substantially parallel to at least one of the shoulder axis and the elbow axis.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a left side perspective view of a robot including a line management system for routing cables/hoses according to an embodiment of the present invention;

FIG. 2 is a right side perspective view of the robot of FIG. 1;

FIG. 3 is a top plan view of the robot of FIG. 1;

FIG. 4 is an enlarged fragmentary cross sectional view of a ribbon of flexible lines of the line management system of FIG. 1, the ribbon including a jacket bundle according to an embodiment of the present invention; and

FIG. 5 is an enlarged fragmentary cross sectional view of the jacket bundle of FIG. 3.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

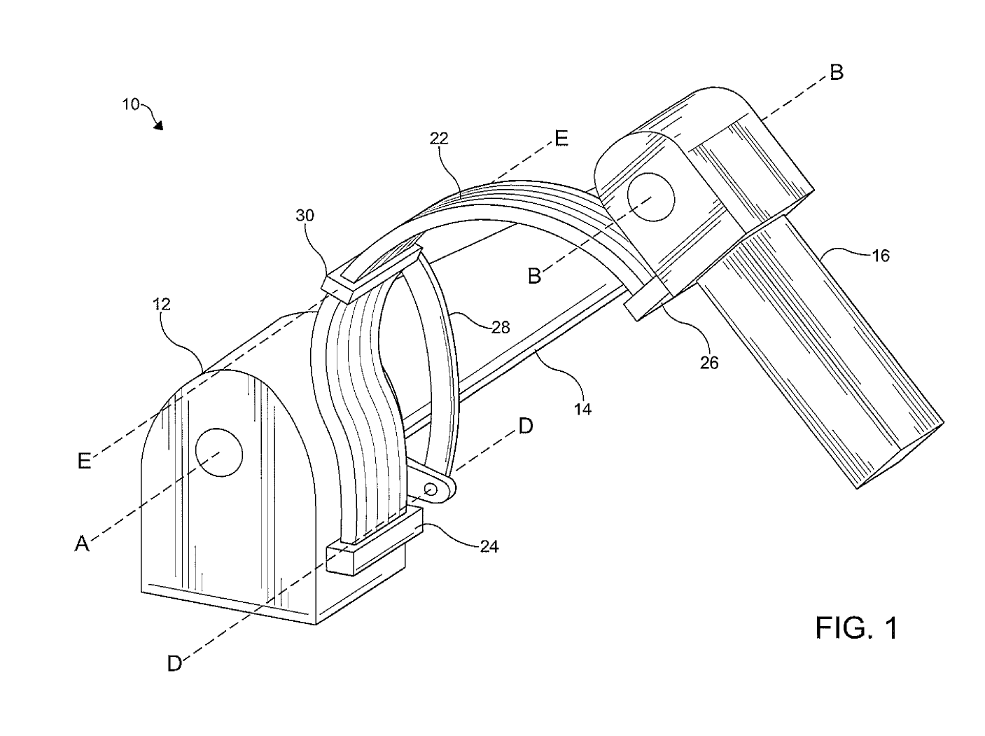

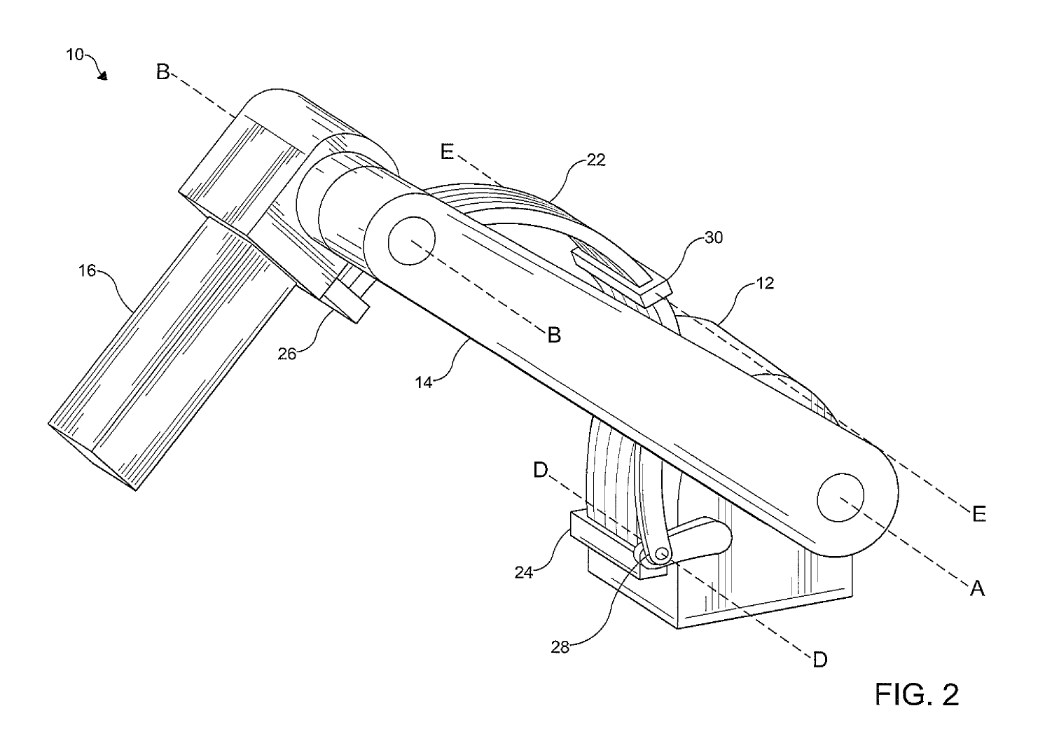

FIGS. 1-3 illustrate a robot 10 according to the present invention. As shown, the robot 10 includes a robot structure 12 (e.g. base/support structure) supporting an inner arm 14 about a rotary shoulder axis A-A. An outer arm 16 is supported by the inner arm 14 about a rotary elbow axis B-B. As a non-limiting example, the shoulder axis A-A and the elbow axis B-B are typically substantially parallel to each other. It is understood that the shoulder axis A-A and the elbow axis B-B can be defined by any parallel rotary axis of the robot 10.

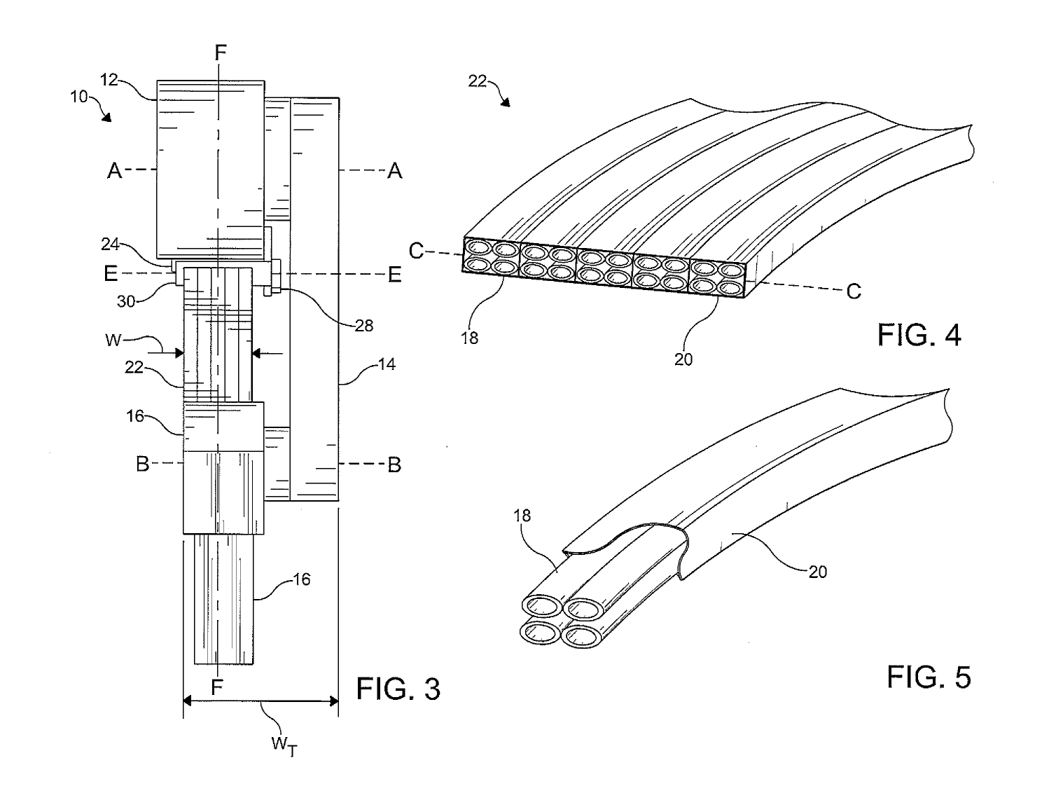

A plurality of flexible lines 18 (e.g. cables, hoses, and the like) are coupled the robot 10 in a manner consistent with the present invention. As a non-limiting example, the flexible lines 18 are grouped into a plurality of jacketed bundles 20 that are arranged in a ribbon 22 having a generally ribbon shaped cross section, as more clearly shown in FIGS. 3-5). In certain embodiments, the jacketed bundles 22 are configured with optimum bending stiffness for a particular application (e.g. to minimize a sag, to optimize a required bend radii, and to maintain a desired motion plane when subjected to lateral acceleration and gravity forces. In certain embodiments, the ribbon 22 of the jacketed bundles 20 has a pre-determined length to minimize an overall length, while supporting a full motion range of the robot arms 14, 16 and maintaining a pre-determined bend radius above a minimum threshold value, as appreciated by one skilled in the art. However, it is understood that the flexible lines 18 can be packaged in any configuration.

A structure clamp 24 attaches a first end end of the ribbon 22 to the robot structure 12 and an arm clamp 26 attaches the a second end (opposite the first end of the ribbon 22) to the outer arm 16 such that an axis C-C (e.g. longitudinal axis, FIG. 4) of a cross section of the ribbon 22 is substantially parallel to the shoulder axis A-A at the first end and the elbow axis B-B at the second end of the ribbon 22. In embodiments where the flexible lines 18 are not arranged as the ribbon 22, an axis of a cross section of at least one of the flexible lines 18 is substantially parallel to at least one of the shoulder axis A-A and the elbow axis B-B.

A crank arm 28 is supported by the robot structure 12 about a rotary crank axis D-D. A coupling device 30 (e.g. a pedal clamp) is mounted to the crank arm 28 on a rotary pedal axis E-E. As a non-limiting example, the shoulder axis A-A, the crank axis D-D, and the pedal axis E-E are substantially mutually parallel. The ribbon 22 is attached to the coupling device 30 at an intermediate point along a length of the ribbon 22 such that the longitudinal axis C-C of a cross-section of the ribbon 22 is substantially parallel to the shoulder axis A-A. As a further non-limiting example, favorable results have been achieved when attaching the coupling device 30 to the ribbon 22 at a point along a length of the ribbon 22 substantially midway between the clamps 24, 26, whereby the ribbon 22 moves in a substantially fixed radius about a point on an outside of the robot structure 12. In this manner the coupling device 30 provides a lateral support for the ribbon 22 and allows the ribbon 22 to distribute a strain energy thereof, without exceeding a minimum bend radius. It is understood that the crank arm 28 and the coupling device 30 constrain the ribbon 22 to militate against a rubbing of the ribbon 22 against an adjacent robot arm. It is understood that the ribbon 22, the structure clamp 24, the arm clamp 26, the crank arm 28, and the coupling device 30 collectively define a line management system according to the present invention. It is further understood that the line management system can include additional components, as desired.

As more clearly shown in FIG. 3, the robot structure 12 and the outer arm 16 share a common plane F-F. The inner arm 14 occupies a space adjacent to and offset from the plane F-F shared by the robot structure 12 and the outer arm 16. The ribbon 22 occupies a space adjacent the inner arm 14 on a side of the inner arm 14 towards the plane F-F. In the configuration shown, a width W of the ribbon 22 does not add to a total width W_{T} of the joints of the robot 10 since the ribbon 22 is positioned between a left boundary at the elbow joint with the axis B-B and a right boundary at the shoulder joint with the axis A-A.

In use, the robot 10 performs an operation by moving the inner arm 14 and the outer arm 16. As the arms 14, 16 move relative to the robot structure 12, the line management system maintains a constrained motion path of the ribbon 22. Specifically, the coupling device 30 cooperates with the crank arm 28 to guide the ribbon along a motion path having a pre-defined path shape (e.g. a substantially circular arc, a substantially elliptical arc, and the like).

The present invention overcomes the shortcomings of the prior art by providing the crank arm 28 to support an arrangement of cables and hoses (e.g. the ribbon 22) in a single location. The arrangement of the cables and hoses (e.g. the ribbon 22) according to the present invention minimizes cost, complexity, and wear on the cables and hose, while maximizing ease of service.

A stiffness of the jacketed bundles 20, a location of the clamps 24, 26, 30, and a geometry of the crank arm 28 are optimized such that the ribbon 22 can bend in a predictable and compact fashion as the robot arms 12, 14 rotate though a useful work envelope. The line management system of the present invention routes the flexible lines 18 to the moving outer arm 16 of the robot 10 in a manner that: maximizes a useful work envelope; minimizes an interference of the flexible lines 18 with items in the surrounding environment; maximizes a flexing life of the flexible lines 18; minimizes a generation of dirt particles from wear; allows for easy replacement of an individual one of the flexible lines 18 without the need to drag it through a flexible conduit or cable track; and minimizes a cost of a support hardware.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A line management system for a robot, the robot including a robot structure supporting an inner arm about a rotary shoulder axis and an outer arm supported by the inner arm about a rotary elbow axis, the system comprising:
a flexible line;
a structure clamp coupled to a first end of the flexible line configured to attach the flexible line to the robot structure, wherein a first axis of a cross section of the flexible line is substantially parallel to the shoulder axis at the first end of the flexible line;
an arm clamp coupled to the second end of the flexible line configured to attach the flexible line to the outer arm, wherein the first axis of a cross section of the flexible line is substantially parallel to the elbow axis at the second end of the flexible line; and
a coupling device moveably coupled to the robot structure, wherein the flexible line is attached to the coupling device at an intermediate point along a length thereof such that the first axis of the cross-section of the flexible line at the intermediate point is substantially parallel to at least one of the shoulder axis and the elbow axis.

2. The system according to claim 1, wherein the flexible line defines a portion of one of a jacket bundle including a plurality of the flexible lines and a ribbon including a plurality of the flexible lines.

3. The system according to claim 1, wherein the flexible line is positioned within a width between boundaries of joints of the inner arm and the outer arm.

4. The system according to claim 1, wherein the structure clamp and the arm clamp are arranged along a common plane.

5. The system according to claim 1, wherein the coupling device is configured to guide the flexible line along a pre-determined motion path.

6. The system according to claim 6, wherein the motion path is one of a substantially circular arc path and a substantially elliptical arc path.

7. The system according to claim 1, wherein the coupling device is pivotally coupled to the robot structure and the flexible line at spaced apart axes.

8. A robot comprising:
a robot structure supporting an inner arm about a rotary shoulder axis and an outer arm supported by the inner arm about a rotary elbow axis;
a plurality of flexible lines arranged in a bundle;
a structure clamp coupled to a first end of the bundle to couple the bundle to the robot structure, wherein a first axis of a cross section of the bundle is substantially parallel to the shoulder axis at the first end of the bundle;
an arm clamp coupled to a second end of the bundle to couple the bundle to the outer arm, wherein the first axis of a cross section of the bundle is substantially parallel to the elbow axis at the second end of the bundle;
a crank arm supported by the robot structure; and
a coupling device mounted to the crank arm, wherein the bundle is attached to the coupling device at an intermediate point along a length thereof to guide the bundle along a pre-determined motion path.

9. The system according to claim 8, wherein the bundle is a jacketed bundle.

10. The system according to claim 8, wherein the bundle includes a substantially ribbon-shaped configuration.

11. The system according to claim 10, wherein the first axis is defined as a longitudinal axis of the bundle.

12. The system according to claim 8, wherein at least two of the bundle, the structure clamp and the arm clamp are arranged along a common plane.

13. The system according to claim 8, wherein the bundle is positioned within a width between boundaries of joints of the inner arm and the outer arm.

14. The system according to claim 8, wherein the first axis of the cross-section of the bundle at the intermediate point is substantially parallel to at least one of the shoulder axis and the elbow axis.

15. The system according to claim 8, wherein the coupling device is pivotally coupled to the crank arm and the bundle at spaced apart axes.

16. The system according to claim 8, wherein the crank arm is pivotably coupled to the robot structure and allowed to move about a rotary crank axis.

17. A method of routing a flexible line for a robot including a robot structure supporting an inner arm about a rotary shoulder axis and an outer arm supported by the inner arm about a rotary elbow axis, the method comprising:
supporting a first end of the flexible line with the robot structure, wherein a first axis of a cross section of the flexible line is substantially parallel to the shoulder axis at the first end of the flexible line;
supporting a second end of the flexible line with the robot structure, wherein the first axis of a cross section of the flexible line is substantially parallel to the elbow axis at the second end of the flexible line; and
supporting an intermediate point along a length of the flexible line such that the first axis of the cross-section of the flexible line at the intermediate point is substantially parallel to at least one of the shoulder axis and the elbow axis.

18. The method according to claim 17, wherein the flexible line defines one of a portion of a jacket bundle including a plurality of the flexible lines and a portion of a ribbon including a plurality of the flexible lines.

19. The method according to claim 17, wherein the structure clamp and the arm clamp are arranged along a common plane.

20. The method according to claim 17, wherein the flexible line is positioned within a width between boundaries of joints of the inner arm and the outer arm.
